(19) United States
(12) Patent Application Publication
(10) Pub. No.: US 2023/0021139 A1
(43) Pub. Date: Jan. 19, 2023

(54) Roof Anchor

(71) Applicants: Nawar Kzeer, Milton (CA); Brandon Braga, Brampton (CA); Carlos Braga, Brampton (CA)

(72) Inventors: Nawar Kzeer, Milton (CA); Brandon Braga, Brampton (CA); Carlos Braga, Brampton (CA)

(21) Appl. No.: 17/378,883

(22) Filed: Jul. 19, 2021

(51) Int. Cl. A62B 35/00

(52) U.S. Cl. CPC A62B 35/0068

(57) ABSTRACT

A device configured for use with a safety lanyard for preventing at least one worker from falling from a roof. The device includes a rod for insertion through roof decking, a hook for engagement with a joist below the roof decking, a plate for abutment against the roof decking, a locking means for tightening the plate against the roof decking, and a fastener for fastening a safety lanyard to the device, thereby anchoring the at least one worker to the roof.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of safety equipment of existing art and more specifically relates to a safety roof anchor.

### RELATED ART

A fall arrest system is a system used to ‘arrest’ a worker in a fall from a working level, such as a roof. Typically, fall arrest systems include anchor means, connectors, body harnesses, lanyards, etc. Roofing can be a particularly difficult task as it not only requires the lifting of heavy equipment and materials, but also necessitates that this be done high above the ground. Thus, the possibility of a serious slip and fall is ever present, and as such, fall arrest systems are a must.

Typically, the anchoring process involves a considerable amount of time and effort, and as such, when workers are performing short tasks, they may neglect to anchor themselves to the roof. This is an obviously dangerous and potentially life threatening issue. Thus, a suitable solution is desired.

### SUMMARY OF THE INVENTION

In view of the foregoing disadvantages inherent in the known safety equipment art, the present disclosure provides a novel safety roof anchor. The general purpose of the present disclosure, which will be described subsequently in greater detail, is to provide an apparatus that quickly and easily anchors a worker to a roof whilst the worker is performing work thereon. The apparatus is for use with a safety lanyard and prevents the worker from falling from the roof.

A device for preventing at least one worker from falling from a roof is disclosed herein. The roof includes a roof decking and a plurality of joists arranged horizontally below the roof decking. The device includes a rod including a first end opposite a second end and a length therebetween. The second end of the rod may be configured for insertion through a surface of the roof decking. The rod may include a substantially vertical axis relative to the roof decking when the second end is inserted therethrough. A hook may located about the second end of the rod and may be configured to engage with one of the plurality of joists (when the second end is inserted through the roof decking). A plate may be located along the length of the rod. The plate may be configured to abut against the surface of the roof decking when the rod is inserted therethrough. Further, a locking means may be attached about the rod and configured to tighten the plate against the surface of the roof decking. A fastener may be attached about the rod and configured to fasten the safety lanyard to the device.

According to another embodiment, a method of using a device for preventing at least one worker from falling from a roof is also disclosed herein. The method includes providing the device as above; making an opening in the roof decking; inserting the second end of the rod through the opening; engaging the hook with said one of the plurality of joists; tightening the plate against the surface of the roof decking via the locking means; and fastening an end of the safety lanyard to the device via the fastener.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a roof anchor, constructed and operative according to the teachings of the present disclosure.

FIG. 1 is a perspective view of a device during an ‘in-use’ condition, according to an embodiment of the disclosure.

FIG. 2 is a close-up perspective view of the device and illustrating the device relative to a roof decking and a plurality of joists, according to an embodiment of the present disclosure.

FIG. 3 is a perspective side view of the device relative to the roof decking and a joist, according to an embodiment of the present disclosure.

FIG. 4 is an exploded view of the device according to an embodiment of the present disclosure.

FIG. 5 is a side view of the device according to an embodiment of the present disclosure.

FIG. 6 is a front view of the device according to an embodiment of the present disclosure.

FIG. 7 is a flow diagram illustrating a method of use for the device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to safety equipment and more particularly to a roof anchor specifically used to anchor at least one worker to a roof whilst the at least one worker performs work thereon. Generally, the roof anchor may be a quick install, portable and lightweight fall arrest anchor that installs onto a structural steel joist through roof decking, causing minimal damage to the roof decking and requiring no repair.

The roof anchor of the present disclosure may install in under 30 seconds and may require no power tools and no patch work. To install, the worker may make a small hole in the roof decking between a joist gap. The worker may then drop the anchor through the hole and hook onto a joist. The worker may then secure the anchor by tightening a handle thereon. Once the roof anchor is secured, the worker may install their lanyard to a rotating tow ring on the anchor. The worker may preferably uninstall and reinstall the roof anchor at different locations as roof decking installation progresses. The quick and easy install may be especially useful to complete tasks along a perimeter of the roof or to accomplish short tasks.

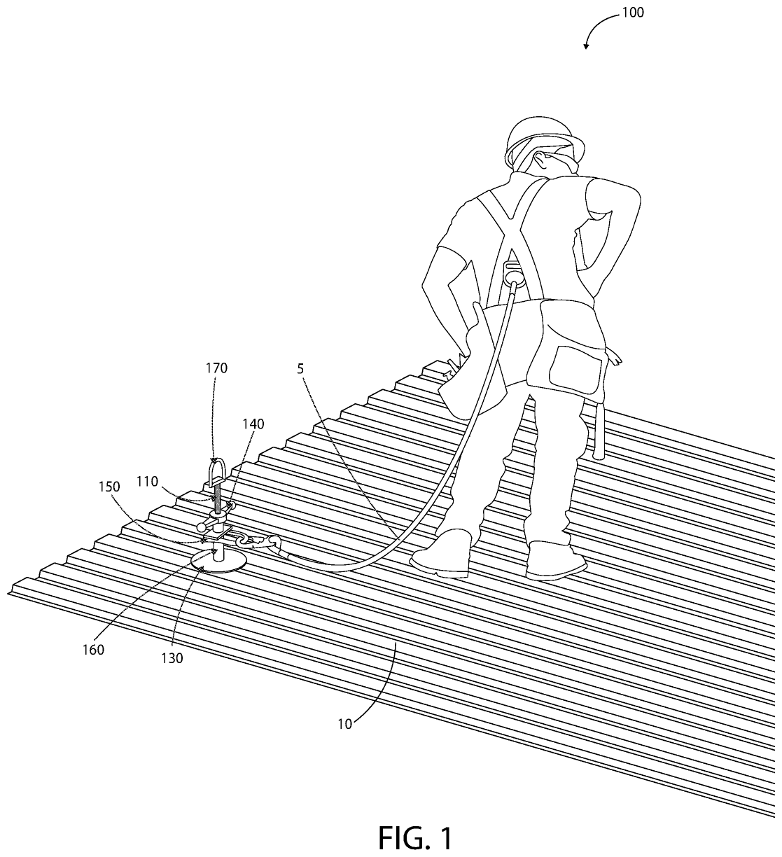

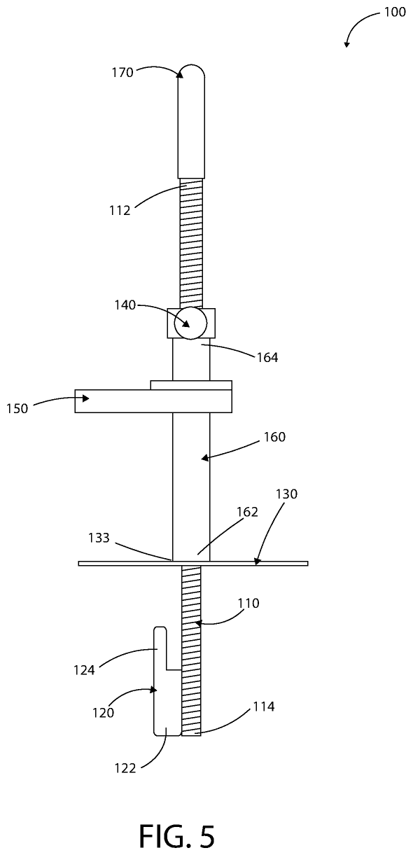

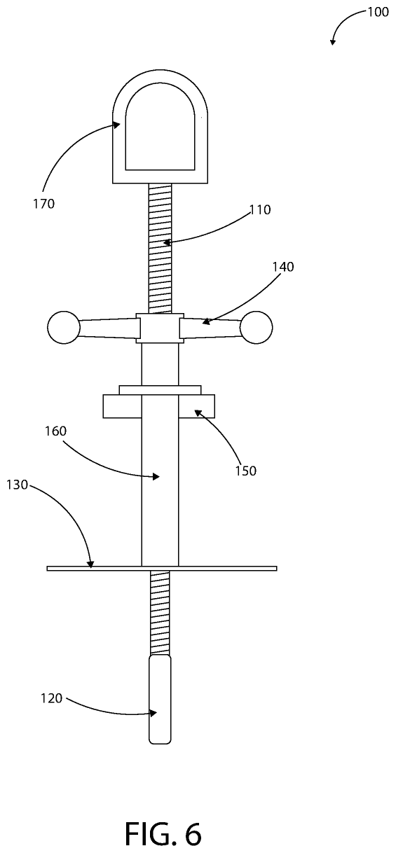

Referring now more specifically to the drawings by numerals of reference, there is shown in FIGS. 1-6, various views of a device 100.

FIG. 1 shows the device 100 during an ‘in-use’ condition, according to an embodiment of the present disclosure. The device 100 may preferably be used with a safety lanyard 5 (as part of a fall arrest system) and configured to prevent at least one worker from falling from a roof 10. In some embodiments, the safety lanyard 5 may be a standard fall arrest safety lanyard, and as such, the device 100 may be configured for use therewith. In other embodiments, or in additional embodiments, the safety lanyard 5 may be provided with the device 100 as part of a kit or system. The device 100 may include a rod 110, a hook 120, a plate 130, a locking means 140, and a fastener 150. Further, in some embodiments, the device 100 may include a device-handle 170 attached about a first end 112 of the rod 110. This may enable quick and easy portability of the device 100.

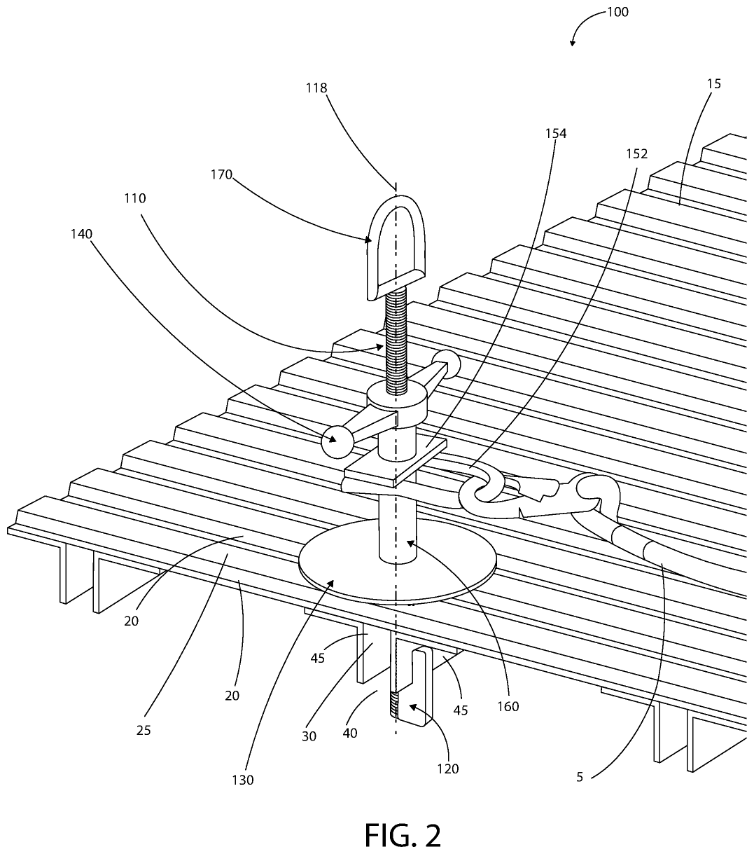

As above, the device 100 may be used for preventing at least one worker from falling from a roof 10. As such, the fastener 150 may be configured to fasten the safety lanyard 5 to the device 100. The fastener 150 may be attached about the rod 110. For example, in some embodiments, the fastener 150 may be attached to a shaft 160 located on the rod 110 (discussed in more detail below). As shown in FIG. 2, the fastener 150 may include a ring 152, and an end of the safety lanyard 5 may be configured to clip to the ring 152 (the other end of the safety lanyard 5 being clipped to the at least one worker, or specifically, a harness worn by the at least one worker). In some embodiments, the fastener 150 may be a tow hook ring 154.

As shown in FIGS. 1-2, the roof 10 may include a roof decking 15 and a plurality of joists 30 arranged horizontally below the roof decking 15. Particularly, the roof decking 15 may be metal roof decking. For example, as shown in FIG. 2, the roof decking 15 may include a corrugated profile being defined by a plurality of alternating peak sections 20 and channel sections 25. As shown, the joists 30 may be defined by two elongated beams 45 having a gap 40 therebetween.

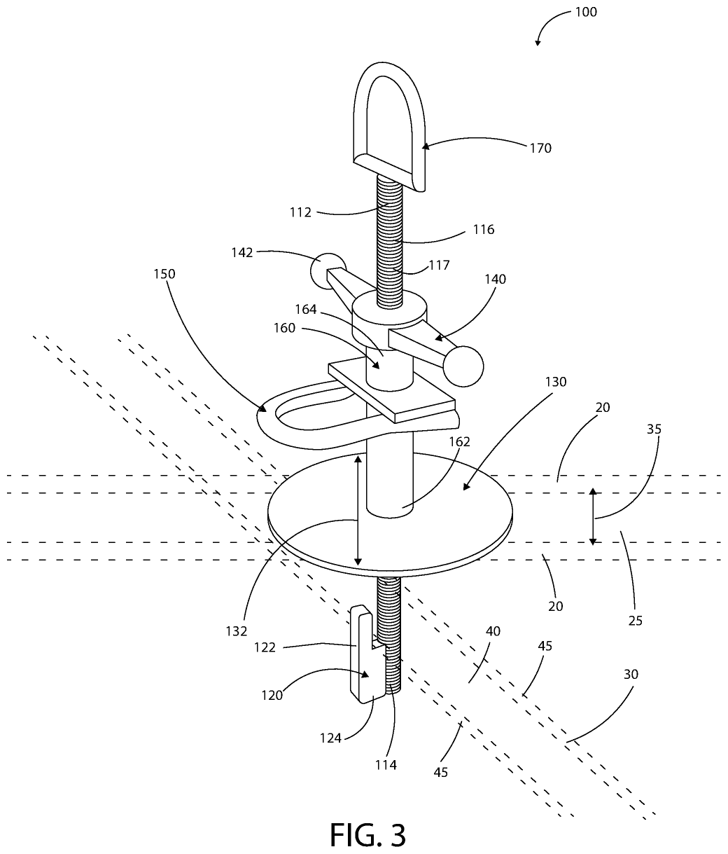

As shown in FIG. 3, the rod 110 may include the first end 112 opposite a second end 114 and a length 116 therebetween. As shown, the rod 110 may be a central body of the device 100 which the plate 130, the locking means 140, the fastener 150 and a shaft 160 (discussed below) circumscribe. In some embodiments, the length 116 of the rod 110 may include threads. For example, the length 116 of the rod 110 may include male threads 117. Preferably, the rod 110 may be made from a durable and sturdy material. For example, the rod 110 may be made from a metal material. As shown in FIGS. 2-3, the second end 114 of the rod 110 may be configured for insertion through a surface of the roof decking 15. For example, in some embodiments, an opening may be made in the roof decking 15 by the at least one worker by hammering an aperture therethrough. Preferably, the second end 114 of the rod 110 may be configured for insertion through a channel section 25 of the roof decking 15.

As shown, the rod 110 may define a substantially vertical axis 118 relative to the roof decking 15 when the second end 114 is inserted therethrough. The fastener 150 may preferably be rotatable about the (substantially) vertical axis 118. For example, the fastener 150 may be configured to rotate 360 degrees about the vertical axis 118 to enable free movement of the at least one worker and easy, quick connection of the safety lanyard 5 to the fastener 150. As shown, the shaft 160 may be attached to a top surface 133 of the plate 130 and may extend vertically upward therefrom.

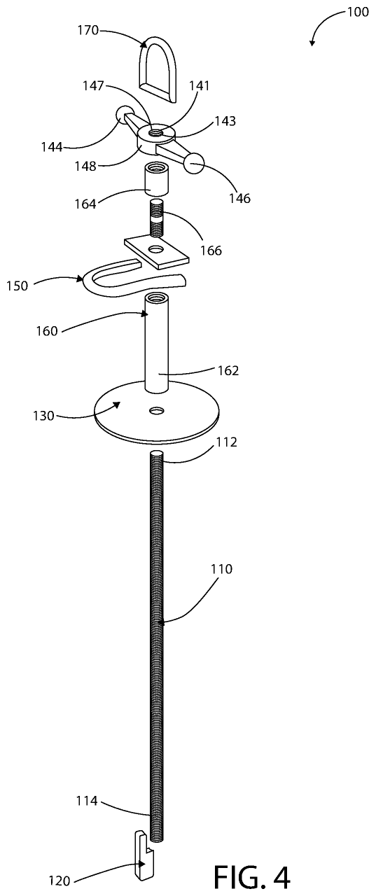

The shaft 160 may include a bottom end 162, a top end 164 and a double-ended bolt 166, as shown in FIG. 4. The double-ended bolt 166 may include both ends having male threads thereon, and the bottom end 162 and the top end 164 may include female threads for mating with the male threads. Further, in between both ends of the double-ended bolt 166 may be an unthreaded section. As shown, in FIG. 3, the fastener 150 may circumscribe the unthreaded section of the double-ended bolt 166, and when the bottom end 162 and the top end 164 are attached to the double-ended bolt 166, the fastener 150 may be safely secured to the shaft 160, preventing the fastener 150 from being removed from the device 100, whilst still allowing for the 360 degree rotation. The double-ended bolt 166 may be hollow to allow for insertion of the rod 110 therethrough.

As shown, the hook 120 may be located about the second end 114 of the rod 110 and, as shown in FIGS. 2-3, the hook 120 may be configured to engage with one of the plurality of joists 30. For example, as shown in FIGS. 2-3, the hook 120 may be slid into the joist gap 40 in between the two elongated beams 45 and the hook 120 may hook onto one of the elongated beams 45. Preferably, the hook 120 may be substantially L-shaped and include a vertical portion 122 and a horizontal portion 124 connecting the vertical portion 122 to the rod 110. The vertical portion 122 may be configured to contact a side one of the elongated beams 45 and the horizontal portion 124 may contact a bottom of one of the elongated beams 45, thereby ‘hooking’ the device 100 to the joist 30.

Preferably, the hook 120 may be made from a durable, sturdy material such as metal. In some embodiments, the hook 120 may be permanently attached to the rod 110. For example, the hook 120 may be welded to the rod 110. This may be ensure stability of the device 100 when inserted through the roof decking 15 and supporting the at least one worker. In other embodiments, the hook 120 may be semi-permanently or removably attached to the rod 110. This may allow for interchangeability of different hooks or other attaching means.

The plate 130 may be located along the length 116 of the rod 110. Preferably, the plate 130 may include a circular shape. However, other shapes are also contemplated. Further, the similarly to the rod 110 and the hook 120, the plate 130 may also be made from the durable, sturdy material discussed above. The plate 130 may be configured to abut against the surface of the roof decking 15 when the rod 110 is inserted therethrough. Preferably, the plate 130 may be located about the length 116 such that when the hook 120 is engaged with one of the plurality of joists 30, a bottom surface of the plate 130 abuts two opposing peak sections 20 (both on opposite sides of the channel section 25 through which the second end 114 of the rod 110 is inserted).

To achieve this, as shown, the plate 130 may include a width 132 larger than a width 35 of each channel section 25. Further, when the plate 130 is an un ‘untightened’ position against the surface of the roof decking 15 (discussed in more detail below), a measurement between the bottom surface of the plate 130 and a top surface of the horizontal section 124 of the hook 120 may be greater than a measurement between a top surface of the peak sections 20 to a bottom surface of the joists 30.

The locking means 140 may be attached about the rod 110 and configured to tighten the plate 130 against the surface of the roof decking 15. As shown in FIG. 4, the locking means 140 may include a lock-handle 142 having a first handle half 144 opposite a second handle half 146, and a mid-section 148. As shown in FIG. 4, the mid-section 148 may include a center-aperture 147 through which the rod 110 is inserted.

Preferably, the lock-handle 142 may be configured for rotation about the rod 110 in the vertical axis 118 to selectively tighten and untighten the plate 130 against the surface of the roof decking 15. For example, the plate 130 may be selectively tightened via rotating the lock-handle 142 down towards the shaft 160. In this example, in some embodiments, a bottom surface of the mid-section 148 may be configured to be selectively tightened against the top end 164 of the shaft 160 to tighten the plate 130 against the roof decking 15. To achieve this rotation, as shown in FIG. 4, walls 141 of the center-aperture 147 may preferably include female threads 143 configured to mate with the male threads 117 of the rod 110.

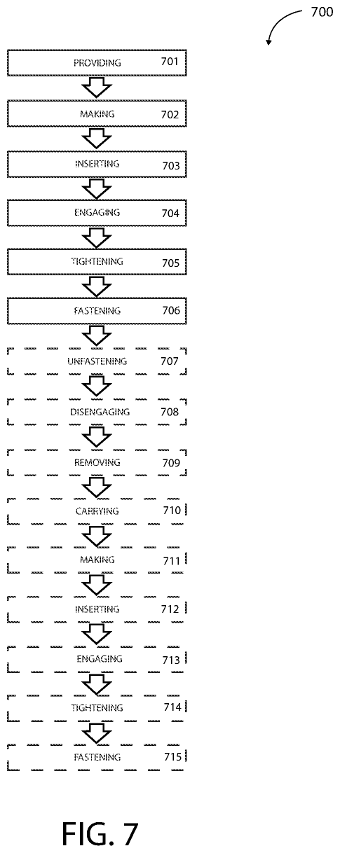

Referring now to FIG. 7 showing a flow diagram illustrating a method of use 700 for the device, according to an embodiment of the present disclosure. In particular, the method of use 700 may include one or more components or features of the device 100 as described above. As illustrated, the method of use 700 may include the steps of: step one 701, providing the device as above; step two 702, making an opening in the roof decking (for example, by hammering, drilling or otherwise making a hole therethrough); step three 703, inserting the second end of the rod through the opening; step four 704, engaging the hook with said one of the plurality of joists; step five 705, tightening the plate against the surface of the roof decking via the locking means; and step six 706, fastening an end of the safety lanyard to the device via the fastener.

Further steps may include: step seven 707, unfastening the end of the safety lanyard from the device; step eight 708, unhooking the hook from said one of the plurality of joists; and step nine 709, removing the device from the roof decking. Further, as above, the device 100 may be easily reinstalled in different locations on the roof. As such, further steps may include: step ten 710, carrying the device to a different location on the roof step eleven 711, making a new opening in the roof decking; step twelve 712, inserting the second end of the rod through the new opening; step thirteen 713, engaging the hook with another one of the plurality of joists; step fourteen 714, tightening the plate against the surface of the roof decking via the locking means; and step fifteen 715, fastening an end of the safety lanyard to the device via the fastener.

It should be noted that steps 707-715 are optional steps and may not be implemented in all cases. Optional steps of method of use 700 are illustrated using dotted lines in FIG. 7 so as to distinguish them from the other steps of method of use 700. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for preventing a worker from falling from a roof are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A device for use with a safety lanyard for preventing at least one worker from falling from a roof, the roof including a roof decking and a plurality of joists arranged horizontally below the roof decking, the device comprising:
a rod including a first end opposite a second end and a length therebetween, the second end of the rod being configured for insertion through a surface of the roof decking, the rod defining a substantially vertical axis relative to the roof decking when the second end is inserted therethrough;
a hook located about the second end of the rod, the hook being configured to engage with one of the plurality of joists;
a plate located along the length of the rod, the plate being configured to abut against the surface of the roof decking when the rod is inserted therethrough;
a locking means attached about the rod, the locking means being configured to tighten the plate against the surface of the roof decking; and
a fastener attached about the rod, the fastener configured to fasten the safety lanyard to the device.

2. The device of claim 1, further comprising a shaft attached to a top surface of the plate and extending vertically upward therefrom.

3. The device of claim 2, wherein the locking means includes a lock-handle having a first handle half opposite a second handle half, and a mid-section, the mid-section including center-aperture through which the rod is inserted.

4. The device of claim 3, wherein the lock-handle is configured for rotation about the rod in the vertical axis to selectively tighten and untighten the plate against the surface of the roof decking.

5. The device of claim 4, wherein a bottom surface of the mid-section is configured to be selectively tightened against a top end of the shaft to tighten the plate against the roof decking.

6. The device of claim 5, wherein the length of the rod includes male threads.

7. The device of claim 6, wherein walls of the center-aperture comprises female threads configured to mate with the male threads of the length.

8. The device of claim 1, wherein the roof decking includes a corrugated profile being defined by a plurality of alternating peak sections and channel sections, wherein the second end of the rod is configured for insertion through a channel section of the roof decking, and wherein the plate is located about the length such that when the hook is engaged with said one of the plurality of joists, a bottom surface of the plate abuts two opposing peak sections.

9. The device of claim 8, wherein the plate includes a width larger than a width of each channel section.

10. The device of claim 1, further comprising a device-handle attached about the first end of the rod.

11. The device of claim 1, wherein the fastener includes a ring, and wherein an end of the safety lanyard is configured to clip to the ring.

12. The device of claim 11, wherein the fastener is attached to the shaft.

13. The device of claim 12, wherein the fastener is rotatable about the vertical axis.

14. The device of claim 13, wherein the fastener is a tow hook ring.

15. The device of claim 1, wherein the hook is substantially L-shaped.

16. A device for use with a safety lanyard for preventing at least one worker from falling from a roof, the roof including a roof decking and a plurality of joists arranged horizontally below the roof decking, the roof decking including a corrugated profile being defined by a plurality of alternating peak sections and channel sections, the device comprising:
a rod including a first end opposite a second end and a length therebetween, the length including male threads, the second end of the rod configured for insertion through a channel section of the roof decking, the rod defining a substantially vertical axis relative the roof decking when the second end is inserted therethrough;
a hook located about the second end of the rod, the hook being at least substantially L-shaped and configured to engage with one of the plurality of joists;
a plate located along the length of the rod such that when the hook is engaged to said one of the plurality of joists, a bottom surface of the plate abuts two opposing peak sections, the plate including a width larger than a width of each channel section;
a shaft attached to a top surface of the plate and extending vertically therefrom;
a locking means attached about the rod, the locking means including a lock-handle having a first handle half opposite a second handle half, and a mid-section, the mid-section including center-aperture through which the rod is inserted, walls of the center-aperture including female threads configured to mate with the male threads of the rod, the lock-handle being configured for rotation about the rod in the vertical axis to selectively tighten and untighten the plate against the surface of the roof decking, the mid-section of the lock-handle being configured to be selectively tightened against a top end of the shaft to tighten the plate against the roof decking;
a fastener attached to the shaft, the fastener including a ring, an end of the safety lanyard being configured to clip to the ring, and wherein the fastener is rotatable about the vertical axis; and
a device-handle attached about the first end of the rod.

17. A method using a device with a safety lanyard for preventing at least one worker from falling from a roof, the roof including a roof decking and a plurality of joists arranged horizontally below the roof decking, the method comprising the steps of:
providing the device including:
a rod including a first end opposite a second end and a length therebetween, the second end of the rod being configured for insertion through a surface of the roof decking, the rod defining a vertical axis relative the roof decking when the second end is inserted therethrough;
a hook located about the second end of the rod, the hook being configured to engage with one of the plurality of joists;
a plate located along the length of the rod, the plate being configured to abut against the surface of the roof decking when the rod is inserted therethrough;
a locking means attached about the rod, the locking means being configured to tighten the plate against the surface of the roof decking; and
a fastener attached to the rod, the fastener configured to fasten the safety lanyard to the device;
making an opening in the roof decking;
inserting the second end of the rod through the opening;
engaging the hook with said one of the plurality of joists;
tightening the plate against the surface of the roof decking via the locking means; and
fastening an end of the safety lanyard to the device via the fastener.

18. The method of claim 17, further comprising the steps of:
unfastening the end of the safety lanyard from the device;
disengaging the hook from said one of the plurality of joists; and
removing the device from the roof decking.

19. The method of claim 18, further comprising the steps of:
carrying the device to a different location on the roof;
making a new opening in the roof decking;
inserting the second end of the rod through the new opening;
engaging the hook with another one of the plurality of joists;
tightening the plate against the surface of the roof decking via the locking means; and
fastening an end of the safety lanyard to the device via the fastener.

20. The method of claim 19, wherein the roof decking includes a corrugated profile being defined by a plurality of alternating peak sections and channel sections, wherein the second end of the rod is configured for insertion through a channel section of the roof decking, wherein the plate is located about the length such that when the hook is engaged with said one of the plurality of joists, a bottom surface of the plate abuts two opposing peak sections, and wherein the plate includes a width larger than a width of each channel section.
